(19) United States
(12) Patent Application Publication
(10) Pub. No.: US 2012/0282514 A1
(43) Pub. Date: Nov. 8, 2012

(54) MICROPOROUS MEMBRANES, METHODS FOR MAKING SAME AND THEIR USE AS BATTERY SEPARATOR FILMS

(75) Inventor: Kazuhiro Yamada, Nasushiobara-shi (JP)

(73) Assignee: TORAY BATTERY SEPARATOR FILM GODO KAISHA, Nasushiobara-shi, Tochigi (JP)

(21) Appl. No.: 13/516,870

(22) PCT Filed: Dec. 15, 2010
(86) PCT No.: PCT/JP2010/073056

§ 371 Date: Jun. 18, 2012

Related U.S. Application Data
(60) Provisional application No. 61/287,919, filed on Dec. 18, 2009.

(30) Foreign Application Priority Data
Feb. 12, 2010 (EP) 10153503.7

(51) Int. Cl. H01M 2/16; B29C 47/88

(52) U.S. Cl. 429/145; 429/249; 429/246; 264/211.12

(57) ABSTRACT

Disclosed herein are microporous polymeric membranes suitable for use as battery separator film. Also disclosed herein is a method for producing such a membrane, batteries containing such membranes as battery separators, methods for making such batteries, and methods for using such batteries.

### PRIORITY CLAIM

This is a national stage of International Application No. PCT/JP2010/073056 filed Dec. 15, 2010, claiming priority based on Provisional Patent Application No. 61/287,919 filed Dec. 18, 2009, and EP 10153503.7 filed Feb. 12, 2010, the contents of all of which are incorporated herein by reference in their entirety.

### FIELD

Disclosed herein are microporous polymeric membranes suitable for use as battery separator film. Also disclosed herein are methods for producing such membranes, batteries containing such membranes as battery separators and methods for making and using such batteries.

### BACKGROUND

Microporous membranes can be used as battery separators in, e.g., primary and secondary lithium batteries, lithium polymer batteries, nickel-hydrogen batteries, nickel-cadmium batteries, nickel-zinc batteries, silver-zinc secondary batteries, etc. When microporous membranes are used for battery separators, particularly lithium ion battery separators, the membranes' characteristics significantly affect the properties, productivity and performance of the batteries. While relatively high separator permeability (generally measured as air permeability) is desirable because it leads to batteries having lower internal resistance, improving this property can lead to a reduction in the membrane's strength. Accordingly, it is desirable for the microporous membrane to have an appropriate balance of air permeability and strength, without degrading other important membrane properties such as thickness uniformity.

One method for producing microporous membranes, called the “wet process” involves extruding a mixture of polymer and diluent, stretching the extrudate, and then removing the diluent. Some prior art references disclose methods for improving membrane properties by way of additional or modified processing steps. For example, Japanese Patent Applications Laid Open No. JP 2001-192487 and JP 2001-172420 disclose examples of relatively thick microporous membranes (27 μm) having relatively large pin puncture strength but with diminished air permeability. The membranes are produced in a wet process that involves a thermal treatment following dry orientation. While such membranes exhibit improved pin puncture strength, they can have undesirably high (poor) air permeability Gurley values.

Other references disclose methods for producing membranes having improved properties by using alternative solvents. For example, U.S. Published Patent Application No. 2006/0103055 discloses microporous membranes having improved air permeability and pin puncture strength characteristics produced from a polyolefin-solvent mixture that undergoes a thermally-induced liquid-liquid phase separation at a temperature not lower than the polyolefin's crystallization temperature. Such solvents are expensive and can be difficult to handle.

Further references propose methods for producing membranes having improved properties by using alternative polyolefins. It is known that membranes containing ultra high molecular weight polyethylene have improved strength. For example, PCT Patent Publication No. WO 2007/015547 discloses a relatively strong membrane produced from a polymer resin comprising ≦15% by mass of ultra-high molecular weight polyethylene (based on the mass of the membrane), the ultra-high molecular weight polyethylene having a mass average molecular weight≧1×10⁶. The film can be produced by extruding a melt kneaded product of the polyethylene resin and a solvent for use for the film formation through a die to give an extrusion molded product, cooling the molded product in such a manner that the temperature distribution is formed in the thickness-wise direction to form a gel sheet, stretching the gel sheet at a temperature falling within the range from a temperature higher by 10° C. than the crystal dispersion temperature of the polyethylene resin and a temperature higher by 30° C. than the crystal dispersion temperature, removing the solvent from the sheet, and then re-stretching the sheet by 1.05 to 1.45 times.

While improvements have been made to improve the strength of microporous membranes, further improvements are desired.

### SUMMARY

One aspect of this disclosure is a method for improving the thickness uniformity and strength of an oriented microporous polymeric membrane formed from a mixture of polymer and diluent, e.g., a polyolefin-diluent mixture. It has been discovered that this can be achieved in a wet process by (i) reducing the relative amount of polymer in the polymer-diluent mixture used to produce and (ii) reducing the temperature to which the mixture is exposed during orientation (the “orientation temperature”) to achieve or exceed a target level of thickness uniformity (e.g., fewer die marks) and strength (e.g., one or more of puncture strength, tensile strength, etc.) for the resulting membrane.

Another aspect of this disclosure is a method for producing a microporous membrane. The method includes the steps of establishing a functional relationship between (i) the relative amount of polymer in the polymer-diluent mixture and (ii) membrane thickness uniformity; determining from the relationship a target amount which, when achieved, results in a microporous membrane having an acceptable thickness uniformity, the target amount being less than about 40.0 wt. % of polymer in the polymer-diluent mixture, based on the weight of the polymer-diluent mixture; setting the relative amount of polymer in the polymer-diluent mixture to achieve the target amount so determined; and producing a microporous membrane having an acceptable thickness uniformity.

In yet another aspect of this disclosure, the method further includes establishing a functional relationship between orientation temperature and membrane strength (e.g., one or more of pin puncture strength, tensile strength, etc.), determining from the relationship a target orientation temperature which, when achieved, results in a microporous membrane having ≧a target level of strength, setting the orientation temperature to achieve the target temperature and producing a microporous membrane having ≧the target level of strength.

Accordingly, in one embodiment, the invention relates to a polymeric membrane, the membrane having a normalized pin puncture strength≧20.0 gF/μm and a normalized air permeability≦50.0 seconds/100 cm³/μm, the membrane comprising a first polymer having an Mw≦1.0×10⁶ and a second polymer having an Mw>1.0×10⁶, the membrane being a microporous membrane that is substantially free of die marks.

In another embodiment, the invention relates to a method for improving the thickness uniformity and strength of a microporous membrane produced by orienting a polymer-diluent mixture at an orientation temperature, comprising the steps of:
(a) reducing the relative amount of polymer in the polymer-diluent mixture to improve the membrane's thickness uniformity; and
(b) reducing the orientation temperature to achieve a target level of membrane strength.

yet another embodiment, the invention relates to a membrane comprising first and third layers and a second layer located between the first and third layers, the first and third layers comprising polyethylene and ≧10.0 wt. % polypropylene based on the weight of the layer (the first or third layer as the case may be), and the second layer comprising ≦1.0 wt. % polypropylene, based on the weight of the second layer, the membrane having a meltdown temperature≧165.0° C., a TD tensile strength≧1.0×10³ Kgf/cm², and a 105° C. heat shrinkage≦8.0% in at least one planar direction, and wherein the membrane is a microporous membrane that is substantially free of die marks.

The invention also relates to the membrane product of any preceding embodiment, the use of the membrane product as battery separator film, and batteries containing such membranes. For example, in an embodiment, the invention relates to a battery comprising an electrolyte, an anode, a cathode, and a separator situated between the anode and the cathode, wherein the separator comprises a membrane having a normalized pin puncture strength≧20.0 gF/1.0 μm and a normalized air permeability≦50.0 seconds/100 cm³/1.0 μm the membrane comprising a first polymer having an Mw≦1.0×10⁶ and a second polymer having an Mw>1.0×10⁶, and wherein the membrane is a microporous membrane that is substantially free of die marks.

### BRIEF DESCRIPTION OF THE DRAWINGS

FIG. 1 shows a membrane thickness profile measured at points along the TD direction of a microporous membrane that is substantially free of die marks (e.g., has acceptable TD thickness uniformity).

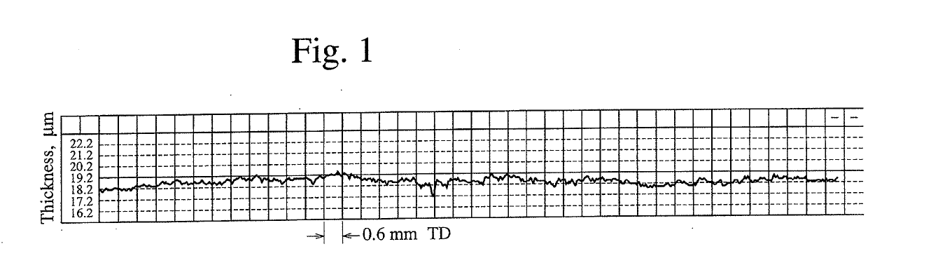

FIG. 2 shows a membrane thickness profile measured at points along the MD direction of a microporous membrane. The illustrated membrane has acceptable MD thickness uniformity.

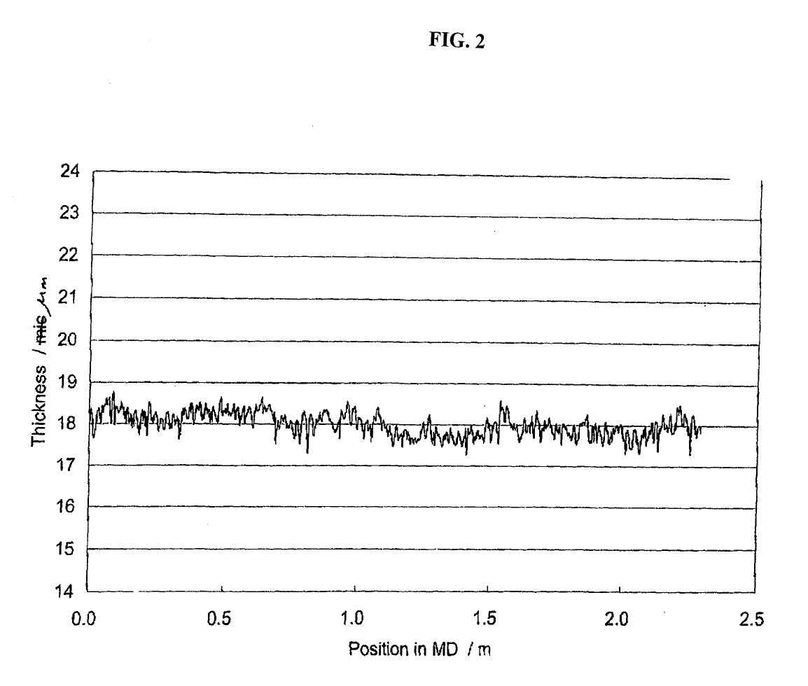

### DETAILED DESCRIPTION

The invention relates to microporous membranes comprising polymer, the membrane having improved thickness uniformity, permeability, and strength. It has been discovered that using polymer having a weight average molecular weight>1.0×10⁶ (e.g., ultra high molecular weight (“UHMW”) polymer such as UHMW polyolefin) to improve membrane strength can result in worsening membrane thickness uniformity. In membranes produced by extrusion, thickness non-uniformity can be observed, e.g., as die marks on the finished membrane. The invention relates in part to overcoming this difficulty by regulating the relative amount of polymer in the polymer-diluent mixture (e.g., the extruder feed) and the extrudate's orientation temperature to produce a membrane of improved strength and thickness uniformity.

Selected forms (embodiments) will now be described in more detail, but this description is not meant to foreclose other forms within the broader scope of this disclosure. For the purpose of this description and the appended claims, the term “polymer” means a composition including a plurality of macromolecules, the macromolecules containing recurring units derived from one or more monomers. The macromolecules can have different size, molecular architecture, atomic content, etc. The term “polymer” includes macromolecules such as copolymer, terpolymer, etc. “Polyethylene” means polyolefin containing ≧50% (by number) recurring ethylene-derived units, preferably polyethylene homopolymer and/or polyethylene copolymer wherein at least 85% (by number) of the recurring units are ethylene units. “Polypropylene” means polyolefin containing >50% (by number) recurring propylene-derived units, preferably polypropylene homopolymer and/or polypropylene copolymer wherein at least 85% (by number) of the recurring units are propylene units. A “microporous membrane” is a thin film having pores, where ≧90.0 percent (by volume) of the film's pore volume resides in pores having average diameters in the range of from 0.01 μm to 10.0 μm. With respect to membranes produced from extrudates, the machine direction (“MD”) is defined as the direction in which an extrudate is produced from a die. The transverse direction (“TD”) is defined as the direction perpendicular to both MD and the thickness direction of the extrudate.

### Composition and Structure of the Microporous Membrane

One form disclosed herein relates to microporous membranes, including monolayer and multilayer membranes, having improved strength, permeability, and thickness uniformity; and an improved balance of these properties. In another form, disclosed herein is a method for producing such membranes. In the production method, an initial method step involves combining polymer resins, e. g., polyolefin resins such as polyethylene resins, with a paraffinic diluent, and then extruding the polymer and diluent to make an extrudate. The process conditions in this initial step can be the same as those described in PCT Publications WO 2007/132942 and WO 2008/016174, for example, which are incorporated by reference herein in their entirety.

In a form, the polymer used to produce the extrudate comprises a first polyethylene having a weight average molecular weight≦1.0×10⁶ and having a terminal unsaturation amount of <0.2 per 10,000 carbon atoms (referred to as the “first polyethylene”) and a second polyethylene, the second polyethylene having a weight average molecular weight>1.0×10⁶.

In a form, the microporous membrane is a monolayer membrane, e.g., it is not laminated or coextruded with additional polymeric layers. It is, however, within the scope of this disclosure for the polymer(s) comprising the monolayer membrane to exhibit a concentration gradient in the thickness direction. This might occur, for example, when the membrane is produced from at least two polymers and the membrane exhibits an increased concentration of one of the constituent polymers near the surface of the membrane.

In another form, disclosed herein is a multilayer polymeric membrane having an improved balance of meltdown temperature, thickness uniformity, and strength. Such layered membranes can be produced by conventional methods such as lamination and co-extrusion, as described in WO 2008/016174, provided (i) the relative amount of polymer in the polymer-diluent mixture and (ii) the orientation temperature are as specified below.

In an embodiment, the membrane can consist essentially of or even consist of polyethylene. In another embodiment polypropylene can be utilized together with the first polyethylene and, optionally, the second polyethylene, to form outer layers (e.g., a skin layers) of a multilayer membrane with at least one core layer located between the outer layers. In yet another embodiment, at least one core layer in the membrane comprises polypropylene.

The first and second polyethylenes, the polypropylene and the paraffinic diluent used to produce the extrudates and the microporous membranes will now be described in more detail. While the invention will be described in terms of a monolayer and multilayer membranes produced in a wet process, it is not limited thereto, and the description is not meant to foreclose other embodiments within the broader scope of the invention.

Materials used to Produce the Microporous Membrane

In one form, the first polyethylene can be, for example, a polyethylene having an a weight average molecular weight (“Mw”)≦1.0×10⁶, e.g., in the range of from about 1.0×10⁵ to about 0.90×10⁶, a molecular weight distribution (“MWD”, defined as Mw divided by the number average molecular weight “Mn”) in the range of from about 2.0 to about 50.0, and a terminal unsaturation amount<0.20 per 1.0×10⁴ carbon atoms. (“PE1”). Optionally, the first polyethylene has an Mw in the range of from about 4.0×10₅ to about 6.0×10⁵, and an MWD of from about 3.0 to about 10.0. Optionally, the first polyethylene has an amount of terminal unsaturation≦0.14 per 1.0×10⁴ carbon atoms, or ≦0.12 per 1.0×10⁴ carbon atoms, e.g., in the range of 0.05 to 0.14 per 1.0×10⁴ carbon atoms (e.g., below the detection limit of the measurement). PE1 can be, e.g., SH-800® or SH-810® high density polyethylene, available from Asahi.

In another form, the first polyethylene has an Mw≦1.0×10⁶, e.g., in the range of from about 2.0×10⁵ to about 0.9×10⁶, an MWD in the range of from about 2 to about 50, and a terminal unsaturation amount≧0.20 per 10,000 carbon atoms (“PE2”). Optionally, the first polyethylene has an amount of terminal unsaturation≧0.30 per 1.0×10⁴ carbon atoms, or ≧0.50 per 1.0×10⁴ carbon atoms, e.g., in the range of 0.6 to 10.0 per 1.0×10⁴ carbon atoms. A non-limiting example of the first polyethylene is one having an Mw in the range of from about 3.0×10⁵ to about 8.0×10⁵, for example about 7.5×10⁵, and an MWD of from about 4 to about 15. PE2 can be, e.g., Lupolen®, available from Basell. The first polyethylene can be a mixture of PE1 and PE2.

PE1 and/or PE2 can be, e.g., an ethylene homopolymer or an ethylene/α-olefin copolymer containing ≦5.0 mole % of one or more comonomer such as α-olefin, based on 100% by mole of the copolymer. Optionally, the α-olefin is one or more of propylene, butene-1, pentene-1, hexene-1, 4-methylpentene-1, octene-1, vinyl acetate, methyl methacrylate, or styrene. Such a polyethylene can have a melting point≧132° C. PE1 can be produced, e.g., in a process using a Ziegler-Natta or single-site polymerization catalyst, but this is not required. The amount of terminal unsaturation can be measured in accordance with the procedures described in PCT Publication WO 97/23554, for example. PE2 can be produced using a chromium-containing catalyst, for example.

In a form, the second polyethylene has an Mw>1.0×10⁶, e.g., in the range of from about 1.0×10⁶ to about 5.0×10⁶ and an MWD of from about 1.2 to about 50.0. A non-limiting example of the second polyethylene is one having an Mw of from about 1.0×10⁶ to about 3.0×10⁶, for example about 2.0×10⁶, and an MWD of from about 2.0 to about 20.0, preferably about 4.0 to 15.0. The second polyethylene can be, e.g., an ethylene homopolymer or an ethylene/α-olefin copolymer containing ≦5.0 mole % of one or more comonomers such as α-olefin, based on 100% by mole of the copolymer. The comonomer can be, for example, one or more of, propylene, butene-1, pentene-1, hexene-1, 4-methylpentene-1, octene-1, vinyl acetate, methyl methacrylate, or styrene. Such a polymer or copolymer can be produced using a Ziegler-Natta or a single-site catalyst, though this is not required. Such a polyethylene can have a melting point≧134° C. The second polyethylene can be ultra-high molecular weight polyethylene (“UHMWPE”), e.g., 240-m® polyethylene, available from Mitsui.

The melting point, Mw, and MWD of the polyethylenes can be determined using the methods similar to those disclosed in PCT Patent Publication No. WO 2008/140835, for example.

In an embodiment, the polypropylene has an Mw≧6.0×10⁵, such as ≧7.5×10⁵, for example in the range of from about 0.9×10⁶ to about 2.0×10⁶. Optionally, the polypropylene has a melting point (“Tm”)≧160.0° C. and a heat of fusion (“ΔHm”)≧90.0 J/g, e.g., ≧100.0 J/g, such as in the range of from 110 J/g to 120 J/g. Optionally, the polypropylene has an MWD≦20.0, e.g., in the range of from about 1.5 to about 10.0, such as in the range of from about 2.0 to about 6.0. Optionally, the polypropylene is a copolymer (random or block) of propylene and ≦5.0 mol. % of a comonomer, the comonomer being, e.g., one or more of α-olefins such as ethylene, butene-1, pentene-1, hexene-1, 4-methylpentene-1, octene-1, vinyl acetate, methyl methacrylate, and styrene, etc.; or diolefins such as butadiene, 1,5-hexadiene, 1,7-octadiene, 1,9-decadiene, etc.

In an embodiment the polypropylene is isotactic polypropylene. The term isotactic polypropylene means polypropylene having a meso pentad fraction≧about 50.0 mol. % mmmm pentads, preferably ≧96.0 mol.% mmmm pentads (based on the total number of moles of isotactic polypropylene). In an embodiment, the polypropylene has (a) a meso pentad fraction≧about 90.0 mol.% mmmm pentads, preferably ≧96.0 mol.% mmmm pentads; and (b) has an amount of stereo defects≦about 50.0 per 1.0×10⁴ carbon atoms, e.g., ≦about 20 per 1.0×10⁴ carbon atoms, or ≦about 10.0 per 1.0×10⁴ carbon atoms, such as ≦about 5.0 per 1.0×10⁴ carbon atoms. Optionally, the polypropylene has one or more of the following properties: (i) a Tm≧162.0° C.; (ii) an elongational viscosity≧about 5.0×10⁴ Pa sec at a temperature of 230° C. and a strain rate of 25 sec₋₁; (iii) a Trouton's ratio≧about 15 when measured at a temperature of about 230° C. and a strain rate of 25 sec₋₁; (iv) a Melt Flow Rate (“MFR”; ASTM D-1238-95 Condition L at 230° C. and 2.16 kg)≦about 0.01 dg/min (i.e., a value is low enough that the MFR is essentially not measurable); or (v) an amount extractable species (extractable by contacting the polypropylene with boiling xylene)≦0.5 wt. %, e.g., ≦0.2 wt. %, such as ≦0.1 wt. % or less based on the weight of the polypropylene.

In an embodiment, the polypropylene is an isotactic polypropylene having an Mw in the range of from about 0.9×10⁶ to about 2.0×10⁶, an MWD in the range of from about 2.0 to about 6.0, and a ΔHm≧90.0 J/g. Generally, such a polypropylene has a meso pentad fraction≧96.0 mol.% mmmm pentads, an amount of stereo defects≦about 5.0 per 1.0×10⁴ carbon atoms, and a Tm≧162.0° C.

A non-limiting example of the polypropylene, and methods for determining the polypropylene's Tm, Mw, MWD, meso pentad fraction, tacticity, intrinsic viscosity, Trouton's ratio, stereo defects, and amount of extractable species are described in PCT Patent Publication No. WO 2008/140835, which is incorporated by reference herein in its entirety.

The polypropylene's ΔHm, is determined using differential scanning calorimetry (DSC). The DSC is conducted using a TA Instrument MDSC 2920 or Q1000 Tzero-DSC and data analyzed using standard analysis software. Typically, 3 to 10 mg of polymer is encapsulated in an aluminum pan and loaded into the instrument at 23° C. The sample is cooled to a temperature≦−70° C. and heated to 210° C. at a heating rate of 10° C./minute to evaluate the glass transition and melting behavior for the sample. The sample is held at 210° C. for 5 minutes to destroy its thermal history. Crystallization behavior is evaluated by cooling the sample from the melt to 23° C. at a cooling rate of 10° C./minute. The sample is held at 23° C. for 10 minutes to equilibrate in the solid state and achieve a steady state. Second heating data is measured by heating this melt crystallized sample at 10° C./minute. Second heating data thus provides phase behavior for samples crystallized under controlled thermal history conditions. The endothermic melting transition (first and second melt) and exothermic crystallization transition are analyzed for onset of transition and peak temperature. The area under the curve is used to determine the heat of fusion (ΔHₘ).

The diluent is generally compatible with the polymers used to produce the extrudate. For example, the diluent can be any species or combination of species capable of forming a single phase in conjunction with the resin at the extrusion temperature. Examples of the diluent include one or more of aliphatic or cyclic hydrocarbon such as nonane, decane, decalin and paraffin oil, and phthalic acid ester such as dibutyl phthalate and dioctyl phthalate. Paraffin oil with a kinetic viscosity of 20-200 cSt at 40° C. can be used, for example. The diluent can be the same as those described in U.S. Patent Publication Nos. 2008/0057388 and 2008/0057389, both of which are incorporated by reference in their entirety.

Optionally, inorganic species (such as species containing silicon and/or aluminum atoms), and/or heat-resistant polymers such as those described in PCT Publications WO 2007/132942 and WO 2008/016174 (both of which are incorporated by reference herein in their entirety) can be used to produce the extrudate. In a form, these optional species are not used.

The final microporous membrane generally comprises the polymer used to produce the extrudate. A small amount of diluent or other species introduced during processing can also be present, generally in amounts less than 1 wt. % based on the weight of the microporous polyolefin membrane. A small amount of polymer molecular weight degradation might occur during processing, but this is acceptable. In a form, molecular weight degradation during processing, if any, causes the value of MWD of the polymer in the membrane to differ from the MWD of the polymer sued to produce the membrane (e.g., before extrusion) by no more than, e.g., about 10%, or no more than about 1%, or no more than about 0.1%.

### Method of Producing the Microporous Membrane

In one form, the invention relates to a method for improving the thickness uniformity and strength of an oriented microporous membrane formed from a polymer-diluent mixture. The method includes the steps of reducing the relative amount of polymer in the polymer-diluent mixture to achieve or exceed a target thickness uniformity of the membrane; and reducing the orientation temperature to achieve or exceed a target membrane strength.

As will be understood by those skilled in the art, the method finds utility, e.g., in cases where die marks (which can be in the form of die lines) are observed in a microporous membrane, the die marks being observed when the membrane is produced from a polymer-diluent mixture having a first relative polymer amount=RPA₁. Accordingly, the amount of polymer in the polymer-diluent mixture can be reduced to a relative polymer amount=RPA₂, to provide a microporous membrane having improved thickness uniformity (e.g., fewer die marks). As will be appreciated, the RPA₁>RPA₂.

As may be expected, when reducing the relative polymer amount while holding other variables constant, the resulting membrane's strength may decrease. In some cases, it may decrease to unacceptable levels. To remedy this, it has been discovered that reducing the orientation temperature can serve to recapture lost strength (e.g., a loss of pin puncture strength) so as to achieve or exceed a target level of membrane strength.

Consequently, in one form the invention relates to a process for producing a microporous membrane. The method includes the steps of establishing a functional relationship between (i) the relative polymer amount (“RPA”) in the polymer-diluent mixture and (ii) and membrane thickness uniformity (e.g., along TD); determining from the relationship a target RPA which, when achieved, results in a microporous membrane having an acceptable thickness uniformity, the target RPA being less than about 40 wt. %, based on the weight of the polymer-diluent mixture; producing a polymer-diluent mixture to achieve the target RPA so determined; and producing a microporous membrane having a desired thickness uniformity.

The step of establishing a functional relationship between RPA and die mark formation may be practiced by generating a thickness profile across TD, the thickness profile comprising ≧2.0×10² equally-spaced points along a 1.0×10² mm portion of TD. The membrane thickness is measured at each point in the profile. A film has acceptable TD thickness uniformity (e.g., is substantially free of die marks) when the difference between the thickness of the membrane at each point in the profile and the thickness at every point within 25.0 mm thereof is ≦1.2 μm.

A thickness profile (e.g., along TD) may be obtained for membranes formed at a variety of RPA values, (e.g., RPA₁, RPA₂, RPA₃, RPA₄, . . . RPAn). Data are regressed to arrive at the value RPA target value to be used in producing the desired polyolefin-diluent mixture, which, when achieved, will result in a microporous membrane having a thickness uniformity as least as good as the desired thickness uniformity. In accordance with one form, the process further includes the steps of establishing a functional relationship between mixture's orientation temperature and the strength (e.g., pin puncture strength, tensile strength, etc.) of the resulting membrane, determining from the relationship a target orientation temperature which, when achieved, results in a microporous membrane having a strength≧the target strength, setting a orientation temperature to achieve the target temperature and producing a microporous membrane having a strength≧the target strength.

### Monolayer Process

In a form, the microporous membrane is a monolayer (i.e., single-layer) membrane produced from an extrudate. The extrudate can be produced from polymer and diluent by a process comprising: combining polymer and diluent, extruding the combined polymer and diluent through a die to form an extrudate; optionally cooling the extrudate to form a cooled extrudate, e.g., a gel-like sheet; optionally stretching the cooled extrudate in MD, TD, or both; removing at least a portion of the diluent from the extrudate or cooled extrudate to form a membrane and optionally removing any remaining volatile species from the dried membrane. Optionally, the dried membrane is stretched in the MD from the first dry length to a second dry length larger than the first dry length by a magnification factor in the range of from about 1.1 to about 1.5 and stretching the membrane in TD from the first dry width to a second width that is larger than the first dry width by a magnification factor in the range of from about 1.1 to about 1.3. Optionally, the membrane is subjected to a controlled in width such as by decreasing the second dry width to a third dry width, the third dry width being in the range of from the first dry width to about 1.1 times larger than the first dry width. The extrudate can be produced continuously from a die, or it can be produced from the die in portions (as is the case in batch processing) for example. An optional hot solvent treatment step, an optional heat setting step, an optional cross-linking step with ionizing radiation, and an optional hydrophilic treatment step, etc., as described in PCT Publication WO 2008/016174 can be conducted if desired. Neither the number nor order of the optional steps is critical.

### Combining Polymer and Diluent

The polymers as described above can be combined, e.g., by dry mixing or melt blending, and then the combined polymers can be combined with at least one diluent (e.g., a membrane-forming solvent) to produce a mixture of polymer and diluent, e.g., a polymeric solution. The diluent can be a diluent mixture. Alternatively, the polymer(s) and diluent can be combined in a single step. The polymer-diluent mixture can contain additives such as one or more antioxidant. In a form, the amount of such additives does not exceed 1 wt. % based on the weight of the polymeric solution.

As will be described in more detail and demonstrated in the Examples that follow, the amount of diluent used to produce the extrudate may be tailored to improve thickness uniformity (e.g., reduce or eliminate die marks) and/or improve membrane strength. For membranes where the targeted properties include MD and TD thickness uniformity, tensile strength, and pin puncture strength, the amount of second polyethylene in the membrane is in the range of 0.5 wt. % to 6.0 wt. %, based on the weight of the membrane. In this case, the amount of polymer in the polymer-diluent mixture is in the range of 30.0 wt. % to 39.0 wt. %, based on the weight of the polymer-diluent mixture, i.e., the RPA is in the range of 30.0 wt. % to 39.0 wt. %. For membranes where the target properties include tensile strength and TD thickness uniformity, the amount of second polyethylene in the membrane is in the range of 35.0 wt. % to 45.0 wt. % (based on the weight of the membrane) and the amount of polymer in the polymer-diluent mixture is in the range of 25.0 wt. % to 28.0 wt. %, based on the weight of the polymer-diluent mixture, i.e., the RPA is in the range of 25.0 wt. % to 28.0 wt. %.

### Extruding

In a form, the combined polymer and diluent are conducted from an extruder to a die. The extrudate or cooled extrudate should have an appropriate thickness to produce, after the stretching steps, a final membrane having the desired thickness (generally 3 μm or more). For example, the extrudate can have a thickness in the range of about 0.1 mm to about 10 mm, or about 0.5 mm to 5 mm. Extrusion is generally conducted with the mixture of polymer and diluent in the molten state. When a sheet-forming die is used, the die lip is generally heated to an elevated temperature, e.g., in the range of 140° C. to 250° C. Suitable process conditions for accomplishing the extrusion are disclosed in PCT Publications WO 2007/132942 and WO 2008/016174.

### Formation of a Cooled Extrudate

The extrudate can be exposed to a temperature in the range of 15° C. to 25° C. to form a cooled extrudate. Cooling rate is not particularly critical. For example, the extrudate can be cooled at a cooling rate of at least about 30° C./minute until the temperature of the extrudate (the cooled temperature) is approximately equal to the extrudate's gelation temperature (or lower). Process conditions for cooling can be the same as those disclosed in PCT Publications No. WO 2008/016174 and WO 2007/132942, for example.

### Stretching the Extrudate (Upstream Orientation)

The extrudate or cooled extrudate can be stretched in at least one direction. The extrudate can be stretched by, for example, a tenter method, a roll method, an inflation method or a combination thereof, as described in PCT Publication No. WO 2008/016174, for example. The stretching may be conducted monoaxially or biaxially, though the biaxial stretching is preferable. In the case of biaxial stretching, any of simultaneous biaxial stretching, sequential stretching or multi-stage stretching (for instance, a combination of the simultaneous biaxial stretching and the sequential stretching) can be used, though simultaneous biaxial stretching is preferable. When biaxial stretching is used, the amount of magnification need not be the same in each stretching direction.

The stretching magnification factor can be, for example, 2 fold or more, preferably 3 to 30 fold in the case of monoaxial stretching. In the case of biaxial stretching, the stretching magnification factor can be, for example, 3 fold or more in any direction, namely 9 fold or more, such as 16 fold or more, e.g. 25 fold or more, in area magnification. An example for this stretching step would include stretching from about 9 fold to about 49 fold in area magnification. Again, the amount of stretch in either direction need not be the same. The magnification factor operates multiplicatively on film size. For example, a film having an initial width (TD) of 2.0 cm that is stretched in TD to a magnification factor of 4 fold will have a final width of 8.0 cm.

The stretching can be conducted while exposing the extrudate to a temperature (the upstream orientation temperature) in the range of from about the Tcd temperature Tm, where Tcd and Tm are defined as the crystal dispersion temperature and melting point of the polyethylene having the lowest melting point among the polyethylenes used to produce the extrudate (i.e., the first and second polyethylene). The crystal dispersion temperature is determined by measuring the temperature characteristics of dynamic viscoelasticity according to ASTM D 4065. In a form where Tcd is in the range of about 90° C. to 100° C., the stretching temperature can be from about 90° C. to 125° C.; e.g., from about 100° C. to 125° C., such as from 105° C. to 125° C. In an embodiment where the amount of second polyethylene in the membrane is in the range of 0.5 wt. % to 6.0 wt. %, based on the weight of the membrane, and the targeted membrane properties include TD thickness uniformity, pin puncture strength, and tensile strength, the extrudate is exposed to a temperature in the range of 117.0° C. to 118.8° C. during the stretching. In an embodiment where the amount of second polyethylene in the membrane is in the range of 35.0 wt. % to 45.0 wt. %, based on the weight of the membrane, and the targeted membrane properties include puncture strength, tensile strength, and TD thickness uniformity, the extrudate is exposed to a temperature in the range of 110.9° C. to 111.6° C. during stretching.

When the sample (e.g., the extrudate, dried extrudate, membrane, etc.) is exposed to an elevated temperature, this exposure can be accomplished by heating air and then conveying the heated air into proximity with the sample. The temperature of the heated air, which is generally controlled at a set point equal to the desired temperature, is then conducted toward the sample through a plenum for example. Other methods for exposing the sample to an elevated temperature, including conventional methods such as exposing the sample to a heated surface, infra-red heating in an oven, etc. can be used with or instead heated air.

### Diluent Removal

In a form, at least a portion of the diluent is removed (or displaced) from the stretched extrudate to form a dried membrane. A displacing (or “washing”) solvent can be used to remove (wash away, or displace) the diluent, as described in PCT Publication No. WO 2008/016174, for example.

In a form, at least a portion of any remaining volatile species (e.g., washing solvent) is removed from the dried membrane after diluent removal. Any method capable of removing the washing solvent can be used, including conventional methods such as heat-drying, wind-drying (moving air), etc. Process conditions for removing volatile species such as washing solvent can be the same as those disclosed in PCT Publication No. WO 2008/016174, for example.

### Stretching the Membrane (Downstream Orientation)

The dried membrane can be stretched (also called “dry stretching” or dry orientation since at least a portion of the diluent has been removed or displaced) in at least MD. Before dry stretching, the dried membrane has an initial size in MD (a first dry length) and an initial size in TD (a first dry width). As used herein, the term “first dry width” refers to the size of the dried membrane in TD prior to the start of dry orientation. The term “first dry length” refers to the size of the dried membrane in MD prior to the start of dry orientation. Tenter stretching equipment of the kind described in WO 2008/016174 can be used, for example.

The dried membrane can be stretched in MD from the first dry length to a second dry length that is larger than the first dry length by a magnification factor (the “MD dry stretching magnification factor”) in the range of from about 1.1 to about 1.5. When TD dry stretching is used, the dried membrane can be stretched in TD from the first dry width to a second dry width that is larger than the first dry width by a magnification factor (the “TD dry stretching magnification factor”). Optionally, the TD dry stretching magnification factor is ≦the MD dry stretching magnification factor. The TD dry stretching magnification factor can be in the range of from about 1.1 to about 1.3. The dry stretching (also called re-stretching since the diluent-containing extrudate has already been stretched) can be sequential or simultaneous in MD and TD. Since TD heat shrinkage generally has a greater effect on battery properties than does MD heat shrinkage, the amount of TD magnification generally does not exceed the amount of MD magnification. When TD dry stretching is used, the dry stretching can be simultaneous in MD and TD or sequential. When the dry stretching is sequential, generally MD stretching is conducted first followed by TD stretching.

The dry stretching can be conducted while exposing the dried membrane to a temperature (the downstream orientation temperature)≦Tm, e.g., in the range of from about Tcd−30° C. to Tm. In a form, the stretching temperature is conducted with the membrane exposed to a temperature in the range of from about 70 to about 135° C., for example from about 80° C. to about 132° C. In a form, the MD stretching is conducted before TD stretching. In an embodiment where membrane tensile strength is improved, e.g., by increasing the amount of second polyethylene in the membrane into the range of 35.0 wt. % to 45.0 wt. %, thickness uniformity can be improved by reducing the upstream orientation temperature into the range of 110.9C to 111.6° C. Should the lower temperature result in a loss of membrane strength, the downstream orientation temperature can be increase into the range of 130.0° C. to 130.6° C. to recover at least a portion of the lost strength without a significant loss of membrane permeability. See, e.g., Examples 9 through 13 below.

In a form, the MD stretching magnification is in the range of from about 1.1 to about 1.5, such as 1.2 to 1.4; the TD dry stretching magnification is in the range of from about 1.1 to about 1.3, such as 1.15 to 1.25; the MD dry stretching is conducted before the TD dry stretching, the MD dry stretching is conducted while the membrane is exposed to a temperature in the range of 80° C. to about 120° C., and the TD dry stretching is conducted while the membrane is exposed to a temperature in the range of 129° C. to about 131° C.

The stretching rate is preferably 3%/second or more in the stretching direction (MD or TD), and the rate can be independently selected for MD and TD stretching. The stretching rate is preferably 5%/second or more, more preferably 10%/second or more, e.g., in the range of 5%/second to 25%/second. Though not particularly critical, the upper limit of the stretching rate is preferably 50%/second to prevent rupture of the membrane.

### Controlled Reduction of the Membrane's Width

Following the dry stretching, the dried membrane can be subjected to a controlled reduction in width from the second dry width to a third width, the third dry width being in the range of from the first dry width to about 1.1 times larger than the first dry width. The width reduction generally conducted while the membrane is exposed to a temperature≧Tcd−30° C., but no greater than Tm. For example, during width reduction the membrane can be exposed to a temperature in the range of from about 70° C. to about 135° C., such as from about 127° C. to about 132° C., e.g., from about 129° C. to about 131° C. The temperature can be the same as the downstream orientation temperature. In a form, the decreasing of the membrane's width is conducted while the membrane is exposed to a temperature that is lower than Tm. In a form, the third dry width is in the range of from 1.0 times larger than the first dry width to about 1.1 times larger than the first dry width.

It is believed that exposing the membrane to a temperature during the controlled width reduction that is ≧the temperature to which the membrane was exposed during the TD stretching leads to greater resistance to heat shrinkage in the finished membrane.

### Heat Set

Optionally, the membrane is thermally treated (e.g., heat-set) at least once following diluent removal, e.g., after dry stretching, the controlled width reduction, or both. It is believed that heat-setting stabilizes crystals and makes uniform lamellas in the membrane. In a form, the heat setting is conducted while exposing the membrane to a temperature in the range Tcd to Tm, e.g., a temperature e.g., in the range of from about 100° C. to about 135° C., such as from about 127° C. to about 132° C., or from about 129° C. to about 131° C. The heat set temperature can be the same as the downstream orientation temperature. Generally, the heat setting is conducted for a time sufficient to form uniform lamellas in the membrane, e.g., a time in the range of 1 to 100 seconds. In a form, the heat setting is operated under conventional heat-set “thermal fixation” conditions. The term “thermal fixation” refers to heat-setting carried out while maintaining the length and width of the membrane substantially constant, e.g., by holding the membrane's perimeter with tenter clips during the heat setting.

Optionally, an annealing treatment can be conducted after the heat-set step. The annealing is a heat treatment with no load applied to the membrane, and can be conducted by using, e.g., a heating chamber with a belt conveyor or an air-floating-type heating chamber. The annealing may also be conducted continuously after the heat-setting with the tenter slackened. During annealing the membrane can be exposed to a temperature in the range of Tm or lower, e.g., in the range from about 60° C. to about Tm−5° C. Annealing is believed to provide the microporous membrane with improved permeability and strength.

Optional heated roller, hot solvent, cross linking, hydrophilizing, and coating treatments can be conducted if desired, e.g., as described in PCT Publication No. WO 2008/016174.

### Multilayer Wet Process Description

In a form, the multi-layer microporous membrane disclosed herein is a two-layer membrane. In another form, the multi-layer microporous membrane has at least three layers. Although this disclosure is not limited thereto, the method for producing the multilayer membrane will mainly be described in terms of a three layer membrane having first and third layers comprising a first layer material and a second layer comprising a second layer material, the second layer being located between the first and third layers. For example, in one embodiment, the membrane comprises a first layer comprising a first layer material, a second layer comprising a second layer material, and a third layer comprising a third layer material. The first and third layers can be of equal thickness and are located on either side of the second layer. In an embodiment, the first and third layer materials each comprise polypropylene. It is believed that when the first and third layers (the “outer” or “skin” layers) comprise a significant amount of polypropylene (e.g., ≧25.0 wt. % based on the weight of the layer), the resulting membrane has a higher meltdown temperature and improved electrochemical stability compared to membranes having skin layers that do not contain a significant amount of polypropylene. A representative multilayer embodiment will now be described. The description is not meant to foreclose other embodiments within the broader scope of the invention.

### Multilayer Embodiment

In a Multilayer Embodiment, the first layer material comprises 40.0 wt. % to 85.0 wt. % polypropylene based on the weight of the first layer material, the polypropylene being an isotactic polypropylene having an Mw≧6.0×10⁵; and (ii) the second layer material comprises polyolefin. The first layer material can further comprise polyethylene, e.g., 25.0 wt. % to 55.0 wt. % polyethylene. For example, the first layer material can comprise 40.0 wt. % to 75.0 wt. % of the polypropylene, from 15.0 wt. % to 60.0 wt. % of a polyethylene having an Mw≦1.0×10⁶ (the “first polyethylene”), and ≦45.0 wt. % of polyethylene having an Mw>1.0×10⁶ (the “second polyethylene”), the weight percents being based on the weight of the first layer material. Optionally, the first layer material comprises 50.0 wt. % to 70.0 wt. % of the polypropylene, e.g., 55.0 wt. % to 65.0 wt. % of the polypropylene.

In this Multilayer Embodiment, the second layer material comprises the first and second polyethylene. For example, the second layer material can comprise ≧50.0 wt. % of the first polyethylene, e.g., in the range of from 55.0 wt. % to 75.0 wt. %, such as 60.0 wt. % to 70.0 wt. %, of the first polyethylene and ≦50.0 wt. % of the second polyethylene, e.g., in the range of from 25.0 wt. % to 45.0 wt. %, such as 30.0 wt. % to 40.0 wt. %, of the second polyethylene, the weight percents being based on the weight of the second layer material. Optionally, (i) the second layer material comprises ≦10.0 wt. % (e.g., 1.0 wt. % to 9.0 wt. %) polypropylene; (ii) the polypropylene of the second layer material is an isotactic polypropylene having an Mw≧6.0×10⁵; and/or (iii) the polypropylene of the second layer material is substantially the same polypropylene as the polypropylene of the first layer material.

In an embodiment, the total amount of polypropylene in the membrane is in the range of 40.0 wt. % to 70.0 wt. %, the total amount of first polyethylene is in the range of 15.0 wt. % to 60.0 wt. %, the total amount of second polyethylene is in the range of 0.0 wt. % to 40.0 wt. %, and the total amount of polyethylene in the membrane is in the range of 80.0 wt. % to 95.0 wt. %, the weight percents being based on the weight of the membrane.

While the first and/or second layer materials can contain copolymers, inorganic species (such as species containing silicon and/or aluminum atoms), and/or heat-resistant polymers such as those described in PCT Publications WO 2007/132942 and WO 2008/016174, these are not required. In an embodiment, the first and second layer materials are substantially free of such materials. Substantially free in this context means the amount of such materials in the layer material is less than 1 wt. % or the total weight of the layer material.

One method for producing the multi-layer microporous membrane disclosed herein comprises layering, such as for example by lamination or coextrusion of extrudates or membranes, e.g., monolayer extrudates or monolayer microporous membranes. For example, one or more layers comprising the first layer material can be coextruded with one or more layers comprising the second layer material, e.g., with the layers comprising the first layer material located on one or both sides of the layers (or layers) comprising the second layer material.

The process for producing the multilayer membrane involves processing a multilayer extrudate in a manner similar to that used for processing the monolayer membrane. The extrudate can comprise at least first, second, and third layers, wherein the second layer is located between the first and third layers. The first and third layers of the extrudate comprise the first layer material and a first diluent, and the second layer of the extrudate comprises the second layer material and a second diluent. The first and third layers can be outer layers of the extrudate, also called skin layers. Optionally, the third layer of the extrudate can be produced from a different layer material, e.g., the third layer material, and could have a different thickness than the first layer. The process also involves stretching the cooled extrudate in MD and/or TD and removing at least a portion of the first and second diluents from stretched extrudate to produce a dried membrane having a first dry length in the in the first planar direction and a first dry width in the second planar direction. As in the case of the monolayer membrane, the process can optionally include stretching the dried membrane along MD and/or TD using the same methods disclosed for stretching the monolayer membrane. Other optional process steps as described for the monolayer membrane can also be used if desired using the same methods disclosed for the monolayer membrane. A form for producing a three-layer membrane will now be described in more detail.

### Combining the First Layer Material and First Diluent

In an embodiment, the first layer material is produced from a first mixture. The first mixture is produced by combining diluent, the polypropylene, first polyethylene, and optionally second polyethylene e.g., by dry mixing or melt blending. The diluent can be, e.g., the same as that used for producing monolayer membranes, such as those described above. As in the case of the monolayer membrane, the first mixture (e.g., the combination of first layer material and diluent) can optionally contain additives such as one or more processing aids (e.g., antioxidant). In a form, the amount of such additives does not exceed 1 wt. % based on the weight of the mixture of polymer and diluent.

The amount of first diluent in the first mixture is in the range 20 wt. % to 99 wt. %, e.g., 25 wt. % to 80 wt. %, such as 70.0 wt. % to 75.0 wt. %, based on the weight of the first mixture. In other words, in one embodiment the RPA for the first mixture is in the range of 25.0 wt. % to 30.0 wt. %, based on the weight of the first mixture.

### Combining the Second Layer Material and Second Diluent

The second layer material is produced from a second mixture, using the same methods used to combine the first layer material and first diluent. For example, the polymer comprising the second layer material can be combined by melt-blending the first polyethylene, the polypropylene, and optionally the second polyethylene, and then combining the melt-blend with diluent. The second diluent can be the same as the first diluent and can be used in the same relative concentration as the first diluent is used in the first mixture. For example, in one embodiment, the RPA for the first mixture is in the range of 25.0 wt. % to 30.0 wt. %, based on the weight of the second mixture.

### Extrusion

In a form, the combined first layer material and first diluent is conducted from a first extruder to first and third dies and the combined second layer material and second diluent is conducted from a second extruder to a second die. A layered extrudate in sheet form (i.e., a body significantly larger in the planar directions than in the thickness direction) can be extruded from the first, second, and third dies to produce a multi-layer extrudate having skin layers of the combined first diluent and first layer material, and a core layer of the combined second layer material and second diluent.

The choice of die or dies and extrusion conditions can be the same as those disclosed in PCT Publication No. WO 2008/016174, for example.

### Cooling the Multilayer Extrudate

The method for cooling the multilayer extrudate is substantially the same as that use to cool the monolayer extrudate. Optionally, the combined thickness of the first and third layers of the extrudate is in the range of 15% to 50% of the cooled extrudate's total thickness; and the second layer has a thickness in the range of 50% to 85% of the cooled extrudate's total thickness. Optionally, the skin layers of the cooled extrudate have substantially the same thickness. The relative thicknesses of the layers of the membrane are approximately in the same proportion as those of the extrudate.

### Stretching the Cooled Extrudate

The cooled extrudate is then stretched in at least one direction (e.g., at least one planar direction, such as MD or TD) to produce a stretched extrudate. Methods similar to those described for stretching the monolayer extrudate can be used. Optionally, the extrudate is stretched simultaneously in MD and TD to a magnification factor in the range of 4 to 6. In a form, the stretching magnification is equal to 5 in MD and TD.

In an embodiment, the stretching is conducted while exposing the extrudate to a temperature in the range of from about the Tcd temperature Tm. In a form where Tcd is in the range of about 90° C. to 100° C., the stretching temperature can be from about 90° C. to 125° C. In an embodiment where at least one skin layer contain a significant amount of polypropylene (e.g., the Multilayer Embodiment described above), the skin layer RPA is in the range of 20.0 wt. % to 35.0 wt. %, e.g., 25.0 wt. % to 30.0 wt. %, and the upstream orientation temperature is in the range of from about 100° C. to 125° C., e.g., from 116.0° C. to 117.5° C.

The remaining process steps (e.g., from Diluent Removal) can be the same as those described in connection with the monolayer process. In the Multilayer Embodiment, the temperature to which the membrane is exposed during downstream orientation and heat setting can be, e.g., in the range of 120.0° C. to 128.0° C., e.g., 123.0° C. to 126.0 ° C.

### Properties and Composition of the Microporous Membrane

In a form, the membrane is liquid-permeable film suitable for use as a battery separator film in lithium ion batteries. Optionally, the membrane can have one or more of the following properties:

### Thickness

The thickness of the final membrane can be ≧1.0 μm, e.g., in the range of about 1.0 μm to about 1.0×10² μm. For example, a monolayer membrane can have a thickness in the range of a bout 10.0 μm to 25.0 μm, and a multilayer membrane can have a thickness in the range of 20.0 μm to 25.0 μm, but these values are merely representative. The membrane's thickness can be measured, e.g., by a contact thickness meter at 1 cm longitudinal intervals over the width of 10 cm, and then averaged to yield the membrane thickness. Thickness meters such as a Model RC-1 Rotary Caliper, available from Maysun, Inc., 746-3 Gokanjima, Fuji City, Shizuoka, Japan 416-0946 or a “Litematic” available from Mitsutoyo Corporation are suitable. Non-contact thickness measurement methods are also suitable, e.g. optical thickness measurement methods.

### Porosity≧20.0%

The membrane's porosity is measured conventionally by comparing the membrane's actual weight to the weight of an equivalent non-porous membrane of 100% polyethylene (equivalent in the sense of having the same length, width, and thickness). Porosity is then determined using the formula: Porosity %=100×(w2−w1)/w2, where “w1” is the actual weight of the membrane, and “w2” is the weight of an equivalent non-porous membrane (of the same polymers) having the same size and thickness. In a form, the membrane's porosity is in the range of 25.0% to 85.0%.

Normalized Air Permeability≦50.0 Seconds/100 cm³/μm

In a form, the membrane has a normalized air permeability≦50.0 seconds/100 cm³/μm (as measured according to JIS P8117). Since the air permeability value is normalized to the value for an equivalent membrane having a film thickness of 1.0 μm, the membrane's air permeability value is expressed in units of “seconds/100 cm³/μm”. Optionally, the membrane's normalized air permeability is in the range of from about 1.0 seconds/100 cm³/μm to about 25 seconds/100 cm³/μm. Normalized air permeability is measured according to JIS P8117, and the results are normalized to the permeability value of an equivalent membrane having a thickness of 1.0 μm using the equation A=1.0 μm*(X)/T₁, where X is the measured air permeability of a membrane having an actual thickness T₁ and A is the normalized air permeability of an equivalent membrane having a thickness of 1.0 μm.

Normalized Pin Puncture Strength≧10.0 gF/μm

The membrane's pin puncture strength is expressed as the pin puncture strength of an equivalent membrane having a thickness of 1.0 μm and a porosity of 40% [gF/μm]. Pin puncture strength is defined as the maximum load measured at ambient temperature when the membrane having a thickness of T₁ is pricked with a needle of 1 mm in diameter with a spherical end surface (radius R of curvature: 0.5 mm) at a speed of 2.0 mm/second. The pin puncture strength (“S”) is normalized to the pin puncture strength value of an equivalent membrane having a thickness of 1.0 μm and a porosity of 40% using the equation S₂=[40%*1.0 μm*(S₁)]/[T₁*(100%−P)], where S₁ is the measured pin puncture strength, S₂ is the normalized pin puncture strength, P is the membrane's measured porosity, and T₁ is the average thickness of the membrane. Optionally, the membrane's normalized pin puncture strength is ≧15.0 gF/μm, or ≧20.0 gF/μm, or ≧25.0 gF/μm, such as in the range of 10.0 gF/μm to 35.0 gF/μm, or 15.0 gF/μm to 25.0 gF/μm. In a particular embodiment, the membrane is a monolayer membrane having a pin puncture strength≧25.0 gF/μm. In another embodiment, the membrane is a multilayer membrane, e.g., the Multilayer Embodiment, and the membrane has a pin puncture strength≧13.0 gF/μm.

Tensile Strength≧1.2×10³ kgF/cm²

Tensile strength is measured in MD and TD according to ASTM D-882A. In a form, the membrane is a monolayer membrane having a TD tensile strength≧1.7×10³ kgF/cm², e.g., in the range of 1.7×10³ kgF/cm² to 2.3×10³ kgF/cm². In another embodiment, the membrane is a multilayer membrane, e.g., the Multilayer Embodiment, having a TD tensile strength≧1.0×10³ kgF/cm², e.g., in the range of 1.0×10³kgF/cm² to 2.0×10³ kgF/cm².

### Shutdown Temperature≦140° C.

The shutdown temperature of the microporous membrane is measured by a thermomechanical analyzer (TMA/SS6000 available from Seiko Instruments, Inc.) as follows: A rectangular sample of 3 mm×50 mm is cut out of the microporous membrane such that the long axis of the sample is aligned with the transverse direction of the microporous membrane and the short axis is aligned with the machine direction. The sample is set in the thermomechanical analyzer at a chuck distance of 10 mm, i.e., the distance from the upper chuck to the lower chuck is 10 mm. The lower chuck is fixed and a load of 19.6 mN is applied to the sample at the upper chuck. The chucks and sample are enclosed in a tube which can be heated. Starting at 30° C., the temperature inside the tube is elevated at a rate of 5° C./minute, and sample length change under the 19.6 mN load is measured at intervals of 0.5 second and recorded as temperature is increased. The temperature is increased to 200° C. “Shutdown temperature” is defined as the temperature of the inflection point observed at approximately the melting point of the polymer having the lowest melting point among the polymers used to produce the membrane. In a form, the shutdown temperature is ≦140.0° C. or ≦130.0° C., e.g., in the range of 128.0° C. to 135.0° C.

### Meltdown Temperature

Meltdown temperature is measured by the following procedure: A rectangular sample of 3 mm×50 mm is cut out of the microporous membrane such that the long axis of the sample is aligned with the transverse direction of the microporous membrane as it is produced in the process and the short axis is aligned with the machine direction. The sample is set in the thermomechanical analyzer (TMA/SS6000 available from Seiko Instruments, Inc.) at a chuck distance of 10 mm, i.e., the distance from the upper chuck to the lower chuck is 10 mm. The lower chuck is fixed and a load of 19.6 mN is applied to the sample at the upper chuck. The chucks and sample are enclosed in a tube which can be heated. Starting at 30° C., the temperature inside the tube is elevated at a rate of 5° C./minute, and sample length change under the 19.6 mN load is measured at intervals of 0.5 second and recorded as temperature is increased. The temperature is increased to 200° C. The meltdown temperature of the sample is defined as the temperature at which the sample breaks, generally at a temperature in the range of about 145° C. to about 200° C. In a form where the membrane is a monolayer membrane that does not contain a significant amount of polypropylene (e.g., ≦2.0 wt. % polypropylene based on the weight of the membrane), the meltdown temperature is in the range of from about 145° C. to about 160° C. In a form where the membrane is a multilayer membrane having at least one skin layer comprising polypropylene, e.g., the Multilayer Embodiment, the membrane has a meltdown temperature≧165.0° C., e.g., ≧170.0° C., such as in the range of 170.0° C. to 200.0° C.

### Thickness Uniformity

### (i) TD Thickness Uniformity

Thickness uniformity is measured with respect to a “planar” direction of the membrane, e.g., an orientation determined when the membrane is substantially flat, such as MD and TD. A membrane has acceptable TD thickness uniformity (e.g., is substantially free of die marks) when the difference between the thickness of the membrane at each point in the TD thickness profile and the thickness at every point within 25.0 mm thereof is ≦1.2 μm, preferably ≦1.0 μm. In an embodiment, the difference between the membrane's thickness at a first point on the membrane's surface and the membrane's thickness at every point within 25.0 mm thereof is ≦1.2 μm, e.g., ≦1.0 μm, for all points on the membrane's surface. The difference between the thickness of the membrane at a first point in the TD thickness profile and the thickness at each point within 25.0 mm of the first point is the “thickness deviation” along TD. A die mark is a region along TD having a size (measured along TD)≦0.05 m and a thickness deviation within the region>1.2 μm, e.g., ≧2.0 μm. A die line is a die mark that propagates along the membrane over a distance in MD of at least about 0.10 m, and generally at least about 1.0 m or even 10.0 m or more. Die lines can form during extrusion, for example. In an embodiment, the membrane's thickness deviation, expressed as a percentage of the membrane's thickness, along any direction of the membrane (MD, TD, etc.) is ≦17.0%, e.g., ≦12.0%, such as ≦10.0%.

TD thickness deviation is measured by generating a TD thickness profile, the TD thickness profile comprising ≧2.0×10² equally-spaced points along a 1.0×10² mm portion of TD. The membrane thickness is measured at each point in the profile.

A contact thickness measuring unit, such as a Model RC-1 Rotary Caliper, available from Maysun, Inc., 746-3 Gokanjima, Fuji City, Shizuoka, Japan 416-0946, detects the distance between a sensor and a pair of measuring rolls to determine the thickness of the film, using a magnetic sensor. After the film is sandwiched between the upper and lower measuring rolls, feed rolls rotate to feed the film. As a result, the upper measuring roll is lifted by the thickness of the film and the distance from the magnetic sensor is changed. This distance change is detected in series the 200 equally-spaced points as the film is fed, then the measurements are converted into thickness data.

For example, a typical width and length for a film sample would be 50 mm in MD and, approximately 1.0 m in TD. When no die marks are present, thickness can vary within a range of 18.2-19.4 μm, for a nominally 18 micron film (a 1.2 micron high-to-low deviation) within 25.0 mm of the measured point. But, when die marks are present, the membrane's thickness at the die mark thickness may be approximately 17.4 μm, yielding a thickness variation in the range of 17.4-19.2 μm, or a 1.8 micron high-to-low deviation within 25.0 mm of at least one measured point.

Optical methods for measuring film thickness and film thickness variation, such as those based on the transmittal or reflectance of light can be used instead of mechanical thickness measurement devices, if desired. For example, in an alternative test, a membrane is considered substantially free of die lines when the membrane has a maximum visible light reflectivity R1 and a minimum visible light reflectivity R2, with (R1−R2)/R1 being ≧0.1.

To measure light reflectivity, a membrane that has been previously produced (and if wound onto a roll is unwound) is passed over an inspection roller where it is illuminated by a light distribution assembly. The light distribution assembly directs a stripe of light across the membrane and the stripe of light is reflected at the membrane surface and then received at a short wave infrared line scan camera containing a linear charge coupled device (CCD).

The data from the CCD array is fed to a line scan processor. The line scan processor divides the data into a plurality of lanes. Pixels from each lane are then compared with a variable threshold value to determine whether the lane corresponds to a die mark region or a region free of die marks.

In another form, the stripe of light is transmitted through the membrane and then received on the other side by the short wave infrared line scan camera containing a linear CCD array. This yields a measure of light transmissivity, rather than reflectivity.

Once again, the data from the CCD array is fed to a line scan processor. The line scan processor divides the data into a plurality of lanes. Pixels from each lane are then compared with a variable threshold value to determine whether the lane corresponds to a die mark region or a region free of die marks. A die mark is determined on the basis that the minimum transmissivity divided by maximum transmissivity from lane to lane<0.90.

The camera can be an indium antimonide focal plane array (InSb FPA) camera, such as offered by Santa Barbara Focalplane of Goleta, Calif., that can cover the entire near infrared range and beyond.

### (ii) MD Thickness Uniformity

Once again, a contact thickness measuring unit, such as a Model RC-1 Rotary Caliper, available from Maysun, Inc., 746-3 Gokanjima, Fuji City, Shizuoka, Japan 416-0946, (or an optical method for measuring thickness) is used to detect the distance between a sensor and a pair of measuring rolls to determine the thickness of the film, using a magnetic sensor. After the film is sandwiched between the upper and lower measuring rolls, feed rolls rotate to feed the film. As a result, the upper measuring roll is lifted by the thickness of the film and the distance from the magnetic sensor is changed. This distance change is detected in series as the film is fed, then the measurements are converted into thickness data.

Thus, a second thickness profile is determined along a second planar direction substantially parallel to the first planar direction, (e.g., along MD when the first planar direction is along TD). The second thickness profile comprises 1.0×10⁴ equally-spaced points along a 1.0 m portion of the second planar direction, with the membrane thickness measured at each point. A membrane is considered to have substantially uniform MD thickness uniformity when the standard deviation of the thickness measurements in the second thickness profile (measured along MD) is ≦1.0 μm.

For membranes having a MD and TD sizes that are different than those described for the above thickness uniformity measurement, the measurements can be scaled to determine the desired profiles, with the number of measurement points per distance along MD and TD in the profiles being the same as described above.

TD Heat Shrinkage Ratio at 105° C. of Less than 10% and MD Heat Shrinkage Ratio at 105° C. of Less than 8.5%

The shrinkage ratio of the microporous membrane orthogonal planar directions (e.g., machine direction or transverse direction) at 105° C. is measured as follows:

(i) Measure the size of a test piece of microporous membrane at ambient temperature in both the machine direction and transverse direction, (ii) equilibrate the test piece of the microporous membrane at a temperature of 105° C. for 8 hours with no applied load, and then (iii) measure the size of the membrane in both the machine and transverse directions. The heat (or “thermal”) shrinkage ratio in either the machine or transverse directions can be obtained by dividing the result of measurement (i) by the result of measurement (ii) and expressing the resulting quotient as a percent.

In an embodiment, the microporous membrane has a TD heat shrinkage ratio at 105° C. in the range of 3.0% to 10%, e.g., 4% to 8%; and an MD heat shrinkage ratio at 105° C. in the range of 1.5% to 8%, e.g., 2% to 6%.

The membrane is permeable to liquid (aqueous and non-aqueous) at atmospheric pressure. Thus, the membrane can be used as a battery separator, filtration membrane, etc. The thermoplastic film is particularly useful as a BSF for a secondary battery, such as a nickel-hydrogen battery, nickel-cadmium battery, nickel-zinc battery, silver-zinc battery, lithium-ion battery, lithium-ion polymer battery, etc. In one form, disclosed herein are lithium-ion secondary batteries containing BSF comprising the thermoplastic film. Such batteries are described in PCT Patent Publication WO 2008/016174, which is incorporated herein by reference in its entirety.

### Microporous Membrane Composition

The microporous membrane generally comprises the same polymers used to produce the polymeric composition, in generally the same relative amounts. Washing solvent and/or process solvent (diluent) can also be present, generally in amounts less than 1 wt % based on the weight of the microporous membrane. A small amount of polymer molecular weight degradation might occur during processing, but this is acceptable. In a form where the polymer is polyolefin and the membrane is produced in a wet process, molecular weight degradation during processing, if any, causes the value of MWD of the polymer in the membrane to differ from the MWD of the polymer used to produce the membrane by no more than about 5%, or no more than about 1%, or no more than about 0.1%.

### Battery Separator and Battery

The microporous membranes disclosed herein are useful as battery separators in e.g., lithium ion primary and secondary batteries. Such batteries are described in PCT publication WO 2008/016174.

The battery is useful as a power source for one or more electrical or electronic components. Such components include passive components such as resistors, capacitors, inductors, including, e.g., transformers; electromotive devices such as electric motors and electric generators, and electronic devices such as diodes, transistors, and integrated circuits. The components can be connected to the battery in series and/or parallel electrical circuits to form a battery system. The circuits can be connected to the battery directly or indirectly. For example, electricity flowing from the battery can be converted electrochemically (e.g., by a second battery or fuel cell) and/or electromechanically (e.g., by an electric motor operating an electric generator) before the electricity is dissipated or stored in a one or more of the components. The battery system can be used as a power source for powering relatively high power devices such as electric motors in power tools.

The various forms disclosed herein will be explained in more detail by referring to Examples below without intention of restricting the scope of this disclosure.

### EXAMPLES

### Monolayer Film Examples

### Examples 1-8

These Examples demonstrate that strength can be optimized, while substantially eliminating die marks, through optimization of the amount of polymer in the polymer-diluent mixture and upstream orientation temperature. As indicated in Table 1, polyolefin compositions are prepared by combining (a) 90-100 wt. % of polyethylene resin having a weight average molecular weight of 5.6×10⁵, a molecular weight distribution of 4.1, and having a terminal unsaturation amount of 0.1 per 10,000 carbon atoms (the first polyethylene) with (b) 0-10 wt. % of polyethylene resin having a weight average molecular weight of 2.0×10⁶ and a molecular weight distribution of 5 (the second polyethylene, identified as UHMWPE).

Also, as indicated in Table 1, 30-40 wt. % of the polyolefin compositions are combined in a strong-blending, double-screw extruder with 60-70 wt. % of liquid paraffin (50 cSt at 40° C.), e.g., RPA is in the range of 30.0 wt. % to 40.0 wt. %. Mixing is conducted at 210° C. to produce the eight polymer-diluent mixtures of Examples 1-8. The mixtures are each extruded from a T-die connected to the double-screw extruder. The extrudates are cooled by contacting the extrudate with cooling rolls having a temperature controlled at 40° C., to form cooled extrudates. Using a tenter-stretching machine, the extrudates (in the form of gel-like sheets) are each simultaneously biaxially stretched (upstream stretching) at an upstream orientation temperature in the range of from 117.0-119.5° C. to 5-fold in both MD and TD. While keeping the size of the sheet fixed, the sheet is then immersed in a bath of methylene chloride controlled at 25° C. (to remove the liquid paraffin) for 3 minutes, and dried by an air flow at room temperature. The dried sheet of each example is then dry-stretched (downstream stretching) in TD to a stretching magnification of 1.4, except for example 7 which is stretched to a magnification factor of 1.35 at an elevated temperature and then heat set for ten minutes.

### Properties

The properties of the microporous membranes obtained in Examples 1-8 are measured by the methods described above. The results are shown in Table 1.

TABLE 1

| | | | | | Normalized | | | MD Thickness |
|---|---|---|---|---|---|---|---|---|
| | UHMWPE | | Upstream | 105° C. | Pin Puncture | TD Tensile | | Uniformity |
| Example | Content | RPA | Orientation | TD Shrink | Strength | Strength | TD Thickness | (standard |
| Number | (wt %) | (wt %) | Temp. (° C.) | (%) | (gf/1.0 μm) | (Kgf/cm²) | Uniformity | deviation) |
| 1 | 0.0 | 40.0 | 118.0 | 3.0 | 26.0 | <1.7 × 10³ | Die Marks | ≦1.0 μm |
| 2 | 1.0 | 40.0 | 119.5 | 2.5 | 18.0 | <1.7 × 10³ | Die Marks | ≦1.0 μm |
| 3 | 2.0 | 40.0 | 119.5 | 2.5 | 24.0 | <1.7 × 10³ | Die Marks | ≦1.0 μm |
| 4 | 2.0 | 39.0 | 118.7 | 2.5 | 24.0 | >1.7 × 10³ | No Die Marks | ≦1.0 μm |
| 5 | 3.0 | 37.5 | 118.0 | 2.5 | 24.0 | >1.7 × 10³ | No Die Marks | ≦1.0 μm |
| 6 | 2.0 | 35.0 | 117.5 | 2.5 | 25.0 | >1.7 × 10³ | No Die Marks | ≦1.0 μm |
| 7 | 5.0 | 30.0 | 117.0 | 2.5 | 21.5 | >1.7 × 10³ | No Die Marks | ≦1.0 μm |
| 8 | 10.0 | 30.0 | 118.0 | 2.5 | 22.0 | <1.7 × 10³ | No Die Marks | >1.0 μm |

The results of Examples 4-8 in Table 1 demonstrate the production of a microporous membrane that is of uniform MD thickness and substantially free of die marks. The membranes of Examples 4-7 have a TD tensile strength>1.7×10³ kgf/cm², a pin puncture strength≧21.5 gf/1.0 μm, and a 105° C. heat shrinkage≦2.5%. As shown above, reducing RPA to less than 40.0 wt. % is found to reduce the number of die marks to the point where they are not detectable. Generally speaking, reducing the RPA from 40% to 39.0% would be expected to result in a lower-strength battery separator film. To recover some of the lost strength (and even improve strength), it was discovered that the upstream orientation temperature could be decreased. As shown by Example 4, reducing the upstream orientation temperature from 119.5° C. to 118.7° C. maintained membrane strength, increased TD thickness uniformity (substantially eliminating die marks), and achieved an acceptable level of TD heat shrinkage at 105° C. It is both surprising and important to note that the TD dry orientation magnification factor value of 1.4 does not need to be increased to improve strength, even though the RPA is reduced. Increasing the TD dry orientation magnification factor to a value≧1.4 would be expected to increase 105° C. TD heat shrinkage, which would be undesirable. All of the examples in the Table have an air permeability≦15 seconds/100 cm³/1.0 μm, including examples 1-3 and 8.

### Examples 9-13

These Examples demonstrate that strength can be optimized without the formation of die marks through the optimization of RPA and upstream orientation temperature in membranes containing 25.0 wt. % to 45.0 wt. % of polyethylene having an Mw>1.0×10⁶ (UHMWPE). As indicated in Table 2, polyolefin compositions are prepared by combining (a) 60-70 wt. % of polyethylene resin having an Mw of 5.6×10⁵, an MWD of 4.1, and having a terminal unsaturation amount of 0.1 per 10,000 carbon atoms (the first polyethylene, identified as HDPE) with (b) 30-40 wt. % of polyethylene resin having an Mw of 2.0×10⁶ and an MWD of 5 (the second polyethylene, identified as UHMWPE).

Also, as indicated in Table 2, 25-28.5 wt. % of the polyolefin compositions are combined in a strong-blending, double-screw extruder with 71.5-75 wt. % of liquid paraffin (50 cSt at 40° C.). Mixing is conducted at 210° C. to produce the five polyethylene-diluent mixtures of Examples 9-13. The mixtures are extruded from a T-die connected to the double-screw extruder. The extrudates are cooled by contacting the extrudate with cooling rolls having a temperature controlled at 40° C., to form cooled extrudates. Using a tenter-stretching machine, the extrudates (in the form of gel-like sheets) are each simultaneously biaxially stretched at upstream orientation temperatures in the range of from 111.0° C.-114.8° C. to 5-fold in both MD and TD. While keeping the size of the sheet fixed, the sheet is then immersed in a bath of methylene chloride controlled at 25° C. (to remove the liquid paraffin) for 3 minutes, and dried by an air flow at room temperature. The dried extrudates are stretched by a batch-stretching machine to a magnification of 1.35-fold in TD while exposed to the specified heat set temperature. The membranes are then heat-set at the specified heat set temperature for 10 minutes. No die marks are observed.

### Properties

The properties of the microporous membranes obtained in Examples 9-13 are measured by the methods described above. The results are shown in Tables 2 and 3, below.

TABLE 2
Starting Materials and Blend Properties for Examples 9-13

| Example | UHMWPE | HDPE | RPA |
|---|---|---|---|
| Number | Content (wt %) | Content (wt %) | (wt %) |
| 9 | 40 | 60 | 25.0 |
| 10 | 40 | 60 | 27.5 |
| 11 | 40 | 60 | 25.0 |
| 12 | 40 | 60 | 25.0 |
| 13 | 30 | 70 | 28.5 |

TABLE 3
Manufacturing Conditions and Basic Properties for Examples 9-13

| | | | | Normalized | | Normalized | | |
|---|---|---|---|---|---|---|---|---|
| | Wet | | | air | | Pin | | |
| | Orientation | Heat Set | | Permeability | | Puncture | Tensile | Shrinkage |
| | Temperature | Temperature | Thickness | (sec/100 | Porosity | Strength | TD | 105° C. |
| Ex. No. | (° C.) | (° C.) | (μm) | cm²/μm) | (%) | (gF/μm) | (kgF/cm²) | TD (%) |
| 9 | 111.5 | 130.5 | 13.5 | 20.2 | 38.1 | 21.8 | 2088 | 3.8 |
| 10 | 111.0 | 130.3 | 13.9 | 17.8 | 40.7 | 23.4 | 2299 | 4.4 |
| 11 | 112.5 | 129.4 | 15.3 | 13.6 | 43.1 | 20.1 | 1838 | 4.7 |
| 12 | 111.5 | 129.2 | 17.1 | 13.5 | 43.8 | 20.53 | 1861 | 5.2 |
| 13 | 114.8 | 128.3 | 22.4 | 11.5 | 45.2 | 19.17 | 1599 | 5.5 |

The results of Table 3 demonstrate that a high-strength microporous membrane that is of uniform MD thickness and substantially free of die marks can be produced from polyolefin. The membranes have a TD tensile strength>1.8×10³ kgF/cm², a pin puncture strength≧21.0 gF/μm. In particular, Examples 9-12 show that microporous membranes having desirable normalized air permeability and normalized pin puncture strength can be produced from an RPA in the range of 25.0 wt. % to 27.5 wt. %. Examples 9-12 show that membranes having a relatively high normalized pin puncture strength≧20.0 gF/μm can be produced without significantly degrading other important membrane properties such as porosity and permeability. Example 13, demonstrates that elevated upstream orientation temperature results in a membrane of significantly lower TD tensile strength and result in higher TD heat shrinkage.

### Multilayer Film Examples

### Examples 14-16

### (1) Preparation of First Polyolefin Solutions

As indicated in Table 4, first polyolefin compositions are prepared by dry-blending (a) 60.0-70.0 wt. % of a first polyethylene resin (“PE1”) having an Mw of 7.5×10⁵ and an MWD of 11.9 and (b) 30.0-40.0 wt. % of a second polyethylene resin (“PE2”) having an Mw of 1.9×10⁶ and an MWD of 5.1. The first polyethylene resin in the composition has a melting point of 135° C. and a Tcd of 100° C.

Also, as indicated in Table 4, 25.0-28.5 wt. % of the resultant first polyolefin compositions are charged into a first strong-blending double-screw extruder having an inner diameter of 58 mm and L/D of 42, and 71.5-75.0 wt. % of liquid paraffin (50 cst at 40° C.) is supplied to the double-screw extruder via a side feeder to produce a first mixture; the weight percents being based on the weight of the first mixture. In other words, the specified RPA is in the range of 25 wt. % to 28.5 wt. %. Melt-blending is conducted at 210° C. and 200 rpm.

### (2) Preparation of Second Polyolefin Solutions

Also, as indicated in Table 4, second polyolefin compositions are prepared in the same manner as the first by dry-blending (a) 30-70 wt. % of the first polyethylene resin (PE1), (b) 0-5.0 wt. % of the second polyethylene resin (“PE2”) and (c) 30-70 wt. % of a polypropylene resin (“PP”) having an Mw of 1.1×10⁶, a heat of fusion of 114 J/g and an MWD of 5, the percentages being based on the weight of the second polyolefin composition. The first polyethylene resin in the composition has a Tm of 135° C. and a Tcd of 100° C. The polypropylene has a Tm≧160.0° C.

Also, as indicated in Table 4, 25-35 wt. % of the resultant second polyolefin compositions are charged into a second strong-blending double-screw extruder having an inner diameter of 58 mm and L/D of 42, and 65-75 wt. % of liquid paraffin (50 cst at 40° C.) is supplied to the double-screw extruder via a side feeder to produce a second mixture, the weight percents being based on the weight of the second mixture. In other words, the specified RPA is in the range of 25.0 wt. % to 35.0 wt. %. Melt-blending is conducted at 210° C. and 200 rpm.

### (3) Production of Membranes

The first and mixtures are supplied from their respective double-screw extruders to a three-layer-extruding T-die, and extruded therefrom to produce layered extrudates of first mixture layer/second mixture layer/first mixture layer at the layer thickness ratios shown in Table 5. The extrudates are cooled while passing through cooling rollers controlled at 20° C., producing extrudates in the form of three-layer gel-like sheets. The gel-like sheets are each biaxially stretched (simultaneously) in MD and TD while exposed to the specified upstream orientation temperature (in the range of 115.0 to 118.5° C.) to a magnification of 5 fold in each of MD and TD by a tenter-stretching machine. The stretched three-layer gel-like sheets are then fixed to an aluminum frame of 20 cm×20 cm, immersed in a bath of methylene chloride controlled at 25° C. for three minutes to remove the liquid paraffin, and dried by air flow at room temperature to produce dried membranes. The dried membranes are then each dry stretched. The membranes are then heat-set while exposed to the specified heat set temperature for 10 minutes to produce the final multi-layer microporous membrane.

The polymers used to produce the membrane and representative process conditions are set out in Tables 4 and 5.

### Properties

The properties of the microporous membranes obtained in Examples 14-16 are measured by the methods described above. The results are shown in Tables 4 and 5, below. No die marks are observed.

TABLE 4
Raw Materials and Blend Properties for Examples 14-16

| | | | | | | | | | Combined skin |
|---|---|---|---|---|---|---|---|---|---|
| | | | | | | | | | layer thickness as |
| | Raw material | | | | Raw material | | | | a % of total |
| | (core layer) | | | | (skin layer) | | | | membrane thickness |
| Ex. No. | PE2 | PE1 | PP | RPA | PE2 | PE1 | PP | RPA | (%) |
| 14 | 30 | 70 | 0 | 28.5 | 0 | 60 | 40 | 30.0 | 19 |
| 15 | 30 | 70 | 0 | 28.5 | 0 | 60 | 40 | 30.0 | 19 |
| 16 | 30 | 70 | 0 | 28.5 | 0 | 50 | 50 | 25.0 | 22 |

TABLE 5
Manufacturing Conditions and Basic Properties for Examples 14-16

| | | | | Normalized | | | | | |
|---|---|---|---|---|---|---|---|---|---|
| | | | | air | Normalized | | | | |
| | Upstream | Heat | Thick- | Permeability | Pin Puncture | Tensile | Shrinkage | Shutdown | Meltdown |
| | orientation | set | ness | (sec/100 | Strength | TD | 105 C. TD | temperature | temperature |
| Ex. No | temperature | temp. | (μm) | cm²/μm) | (gF/μm) | (kgF/cm²) | (%) | (° C.) | (° C.) |
| 14 | 117.0 | 123.6 | 18 | 18.33 | 15.35 | 1.0 × 10³ | 6.0 | 129.6 | 175.8 |
| 15 | 116.0 | 125.6 | 18 | 16.11 | 16.87 | 1.1 × 10³ | 7.5 | 133.1 | 173.7 |
| 16 | 116.0 | 123.6 | 18 | 17.0 | 15.35 | 1.3 × 10³ | 5.5 | 130.6 | 172.4 |

These examples demonstrate that a multilayer microporous membrane can be produced, wherein the membrane has a meltdown temperature≧170.0° C., a TD tensile strength≧1.0×10³ kgF/cm², and a heat shrinkage≦7.5%. In particular, Examples 14 and 15 demonstrate that lower upstream orientation temperature can result in higher TD tensile strength. Example 16 demonstrates that reducing the upstream orientation temperature and reducing the RPA results in an even further increase in TD tensile strength, even when skin layer thickness is increased. Moreover, the Examples presented above demonstrate that a high strength grade of battery separator film may be produced without the added complexity of high biaxial stretching magnification or the use of MD dry orientation which increases MD heat shrinkage or increased TD dry orientation which increases TD heat shrinkage, thus achieving high strength without over-stretching of the film.

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all inventive features which reside herein, including all features which would be treated as equivalents thereof by those skilled in the art to which this disclosure pertains.

When numerical lower limits and numerical upper limits are listed herein, ranges from any lower limit to any upper limit are contemplated. Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise.

Each of the following terms: “includes,” “including,” “has,” “having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein. Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

1.-25. (canceled)

26. A monolayer or multilayer membrane, the membrane having a normalized pin puncture strength≧20.0 gF/μm and a normalized air permeability≦50.0 seconds/100 cm³/μm, the membrane comprising a first polymer having an Mw≦1.0×10⁶ and a second polymer having an Mw>1.0×10⁶, the membrane being a microporous membrane that is substantially free of die marks.

27. The membrane of claim 26, wherein the difference between the membrane's thickness at a first point on the membrane's surface and the membrane's thickness at every point within 25.0 mm thereof is ≦1.2 μm for all points on the membrane's surface.

28. The membrane of claim 26, wherein the membrane has a maximum visible light reflectivity R1 and a minimum visible light reflectivity R2, with (R1−R2)/R1 being ≧0.1.

29. The membrane of claim 26, wherein the first polymer is a first polyethylene, the second polymer is a second polyethylene, and the membrane comprises 0.5 wt. % to 55.0 wt. % of the second polyethylene based on the weight of the membrane.

30. The membrane of claim 29, wherein the membrane is a monolayer membrane comprising the second polyethylene in an amount in the range of 0.5 wt. % to 6.0 wt. %, based on the weight of the membrane, the membrane having a TD tensile strength≧1.7×10³ kgF/cm².

31. The membrane of claim 29, wherein the microporous membrane is a monolayer membrane comprising the second polyethylene in an amount in the range of 35.0 wt. % to 45.0 wt. %, the membrane having a TD tensile strength≧1.8×10³ kgF/cm².

32. A battery separator comprising the membrane of any preceding claim.

33. A method for producing a monolayer or multilayer microporous polymeric membrane, comprising,
(i) forming a polymer-diluent mixture comprising a diluent and polymer,
(ii) producing an extrudate comprising the polymer-diluent mixture, and
(iii) orienting the extrudate at an orientation temperature,
and further comprising the following steps for improving the appearance and strength of the microporous polymeric membrane,
(a) observing at least one die line on the microporous polymeric membrane;
(b) reducing the amount of polymer in the polymer-diluent mixture from a first relative polymer amount to a second relative polymer amount to produce fewer die lines on the microporous polymeric membrane; and
(c) reducing the orientation temperature from a first temperature to a second temperature to achieve or exceed a target level of membrane strength.

34. The method according to claim 33, wherein the polymer comprises about 0.5 to about 55 weight percent of a first polyethylene having an Mw≦1.0×10⁶ and a second polyethylene having an Mw>1.0×10⁶.

35. The method according to claim 34, wherein the polymer comprises 0.5 to 6.0 wt. % of the second polyethylene and the second relative polymer amount is in the range of 30.0 wt. % to 39.0 wt. % based on the weight of the polymer-diluent mixture.

36. The method according to claim 35, wherein the extrudate is biaxially oriented and the second temperature is in the range of from 117.0° C. to 118.8° C.

37. The method according to claim 34, wherein the polymer comprises 35.0 wt. % to 45.0 wt. % of the second polyethylene and the second relative polymer amount is in the range of 25.0 wt. % to 28.0 wt. %, based on the weight of the polymer-diluent mixture.

38. The method according to claim 37, wherein the polymer comprises about 37 wt. % to 42 wt. % of the second polyethylene.

39. The method according to claim 38, wherein the extrudate is biaxially oriented and the second temperature is in the range of from 110.9° C. and 111.6° C.

40. The membrane product of claim 33.

41. A battery comprising an electrolyte, an anode, a cathode, and a separator situated between the anode and the cathode, wherein the separator comprises a membrane having a normalized pin puncture strength≧20.0 gF/μm and a normalized air permeability≦50.0 seconds/100 cm³/μm, the membrane comprising a first polymer having an Mw≦1.0×10⁶ and a second polymer having an Mw>1.0×10⁶, and wherein the membrane is a microporous membrane that is substantially free of die marks.

42. A membrane, comprising first and third layers and a second layer located between the first and third layers, the first and third layers comprising polyethylene and ≧10.0 wt. % polypropylene based on the weight of the layer, and the second layer comprising ≦1.0 wt. % polypropylene, based on the weight of the second layer, the membrane having a meltdown temperature≧165.0° C., a TD tensile strength≧1.0×10³ kgF/cm², and a 105° C. heat shrinkage≦8.0% in at least one planar direction, and wherein the membrane is a microporous membrane that is substantially free of die marks.

43. A membrane comprising a first polymer having an Mw≦1.0×10⁶ and a second polymer having an Mw>1.0×10⁶, the membrane having a normalized pin puncture strength≧20.0 gF/μm and a normalized air permeability≦50.0 seconds/100 cm³/μm, wherein the membrane is microporous and wherein the membrane has a thickness deviation≦17.0% along any direction of the membrane.

44. The membrane of claim 43, wherein the membrane has a meltdown temperature≧165.0° C., a TD tensile strength≧1.0×10³ kgF/cm², and a 105° C. heat shrinkage≦8.0% in at least one planar direction.

45. The membrane of claims 43, the membrane being an extruded membrane that is substantially free of die lines.
